(19) United States
(12) Patent Application Publication
(10) Pub. No.: US 2009/0011090 A1
(43) Pub. Date: Jan. 8, 2009

(54) SYSTEMS AND METHODS FOR PRODUCING EXTRUDED FISH PRODUCT FOR USE IN FISH FARMING

(75) Inventors: Philippe Charat, Rancho Santa Fe, CA (US); Marisol Valdez, Ensenada (MX)

Correspondence Address: BAKER & MCKENZIE LLP;PATENT DEPARTMENT, 2001 ROSS AVENUE, SUITE 2300, DALLAS, TX, 75201, US

(73) Assignee: MARICULTURA DEL NORTE, S DE R.L. DE C.V., Ensenada (MX)

(21) Appl. No.: 12/051,734

(22) Filed: Mar. 19, 2008

Related U.S. Application Data
(60) Provisional application No. 60/895,641, filed on Mar. 19, 2007.

(51) Int. Cl. A23L 1/325; A23L 1/302

(52) U.S. Cl. 426/72; 426/105

(57) ABSTRACT

A sausage like fed product comprises a casing that can be formed form natural material such as pig intestines or collagen or cellulose. The contents of the sausage like feed product can include feed content comprising at least one fish type, such as sardines, mackerel, squid, etc., and additives designed to increase the fat content of fish given the feed product as well as to optimize or increase other aspects of the feed product. The sausage like fed product also includes an optimal shape designed to make the feed product attractive to the fish, and an optimal size based on the size of the fish being fed the feed product.

### RELATED APPLICATIONS INFORMATION

This application claims the benefit under 35 U.S.C. 119(e) to U.S. Provisional Patent Application Ser. No. 60/895,641, filed Mar. 19, 2007 and entitled “Systems and Methods for Producing Extruded Fish Product for Use in Fish Farming,” which is incorporated herein by reference in its entirety as if set forth in full.

### BACKGROUND

1. Field of the Invention

The embodiments described herein are related to farming fish, in particular, and more particularly to generating an extruded feed product that has a high protein concentration.

2. Background of the Invention

As global fish stocks are depleted in order to satisfy the increasing demand of a growing society, fish farming has taken on a more prominent role in meeting the world's food fish demand. A variety of fish can be farmed using conventional techniques. Some of these fish types can actually be bred and raised entirely in captivity; however, for other types of fish it is not economically viable to breed them in captivity and therefore must be captured, placed in fish farms, and then fed and cared for until they have reached an appropriate condition for harvesting. One example of a fish that has been farmed in such a manner is the bluefin tuna.

Accordingly, bluefin tuna are typically captured at sea and transported live to large holding pens near shore into which the fish are released. The fish are then fed, typically sardines, until they have reached the appropriate condition, e.g., size for harvesting. In this manner, the market's demand for bluefin tuna can be met with a smaller amount of captured fish.

The rate at which the fish grow is a function of the amount of protein fed to them, i.e., the amount of protein contained in the sardines fed to the captive fish. Unfortunately, a live sardine is approximately 70-80% water. Therefore, approximately 70-80% of the feed contains no protein at all. In certain instances, the sardines are caught, frozen, transported to a fish farm, de-frosted, and then fed to the fish. This process only acts to reduce the percentage of the feed provided to the fish that actually comprises any nutrients. Therefore it can take as much as 15 tons of feed to convert into one ton of fish. Currently there is approximately 30 tons of bluefin tuna in fish farms around the world, which means that 450 tons of feed, i.e., sardines, etc., would be needed to achieve the desired growth rate for the 30 tons of bluefin tuna in farms.

### SUMMARY

A sausage like fed product comprises a casing that can be formed from natural material such as pig intestines or collagen or cellulose. The contents of the sausage like feed product can include feed content comprising at least one fish type, such as sardines, mackerel, squid, etc., and additives designed to increase the fat content of fish given the feed product as well as to optimize or increase other aspects of the feed product. The sausage like fed product also includes an optimal shape designed to make the feed product attractive to the fish, and an optimal size based on the size of the fish being fed the feed product.

In one aspect, the additives are designed to increase or affect at least one of the quality and color of the fish.

In another aspect, the additives are designed to effect at least one of the sent and color of the feed product.

In still another aspect, the additives include at least one of fish oil, fats from vegetables, vitamins, krill, and fish meal.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating the fat content in sardines used to feed farmed tuna for the 2006-2007 season in comparison with previous years;

FIG. 2 is a diagram illustrating the quantity of fish oil that remained adhered to frozen sardines compared to fresh sardines when testing was performed to try and increase the fat content of farmed tuna;

FIG. 3 is a diagram illustrating the percent of product sold that had a condition index below the desired range (21-23);

FIG. 4 is a diagram illustrating that the percent of a sample tuna population that had a CI below that desired (>21);

FIG. 5 is a diagram illustrating the variations of the CI per harvest of a sample set of farmed tuna;

FIG. 6 is a diagram illustrating the percent of a sample tuna population that had a CI above that desired (>21);

FIG. 7 is a diagram illustrating the distribution of the CI for a sample set of tuna;

FIG. 8 is a diagram illustrating an example that demonstrates the differences in sardine consumption in a pen with a LOW tuna population;

FIGS. 9-11 provide a comparison of quality of tuna obtained in relation to sardine consumption;

FIG. 12 provides an example that demonstrates differences in sardine consumption in pens with HIGH and LOW tuna populations.

FIGS. 13 and 14 provide a comparison of quality obtained in relation to sardine consumption;

FIG. 15 is a diagram illustrating the conditions of the marine environment on a sample set of tuna;

FIGS. 16-19 are diagrams illustrating the distribution of the conditions indexes of a sample set of tuna;

FIG. 20 is a diagram illustrating fats in sardines for the 04-05, 05-06 and 06-07 seasons;

FIG. 21 is a diagram illustrating the sardine fats for the 06-07 season;

FIG. 22 is a diagram illustrating hematological data for the 04-05, 05-06 and 06-07 seasons.

FIG. 23 is a diagram illustrating the hematological data for more stressed pens versus less stressed pens of tuna;

FIG. 24 is a diagram illustrating the blood cholesterol of the tuna, which indicates the presence of sardine fat;

FIG. 25 FIG. 23 is a diagram illustrating the blood hemoglobin of a sample set of tuna; and

FIGS. 26 and 27 are diagrams illustrating the sardine consumption trend in the 06-07 and 04-05 seasons.

### DETAILED DESCRIPTION

Systems and methods for producing an extruded food product for feeding to farmed fish, i.e., bluefin tuna are described below. Feed, such as sardines, are extruded into a sausage-like product in order to increase the amount of protein per ton of feed delivered to captive fishes. By increasing the percentage of protein in the feed, significantly less feed by weight is needed to achieve a desired growth rate. Moreover, as described below, certain additives can be added to the feed in order to increase fat content, quality, color, etc., of the harvested fish.

In order to create the sausage-like feed product, sardines, or as explained below other fish types, are extruded into a casing and formed into a certain length in a certain shape. The length and shape are important. The size of the feed is related to the size of the fish being fed. If a smaller fish is being fed, then a smaller feed fish, such as sardines is required, because the fish will not be able to eat a larger feed fish, such as a mackerel. As the fish grows, however, the size of the feed can increase. Thus, depending on the stage, a larger fish, such as mackerel, can be too big and therefore ineffective as a feed fish. Other fish types, such as anchovies, might be too small.

Another consideration is how the feed product looks to a fish. If the shape is unacceptable to the fish then the fish may not eat it. Accordingly, effort has been made to create an extruded sausage-like feed product that has the right shape and length so as to be acceptable to the target fish; however, because the feed fish is being extruded into a casing that comprises the right length and shape, this opens up the possibility of using other types of feed fish. For example, mackerel, anchovy, squid or other fish can be combined with the sardines or used on their own in order to create the extruded, sausage-like feed product. This can potentially decrease cost, if for example; other types of feed fish are more available or can be obtained at lower cost.

By extruding the feed fish into a sausage-like feed product, the amount of moisture in the product can be driven down and the amount of protein in the product can be increased significantly. Thus, the amount of protein and calories delivered to the fish can be increased significantly, which allows the fish to grow much larger in a much faster period of time. This can further drive down cost significantly because significantly less feed product is needed to achieve the desired growth. Moreover, the fish need to be held for less time, which can also reduce operating cost. Alternatively, the fish can be kept for the same amount of time but larger fish can be produced.

Further, the extruded product can be frozen or shipped anywhere in the world. Because fewer products will need to be shipped, shipping and freight cost can be reduced significantly as well. More efficient, automated feeding techniques can also be deployed in order to deliver the extruded feed product, which can further reduce operating and labor costs. For example, currently fresh sardines are released into the pen and someone watches to ensure that the fish are eating the sardines. Once the observer notices that the fish have stopped eating, then the supply of feed fish into the pen will be shut off. Because the feed fish are fresh, the mechanisms for delivering them into the pen are limited; however, with an extruded feed product, different, more automated mechanisms can be made available. For example, a system of shunts can be created that deliver pre-determined amounts of the extruded product into various holding pens. Cameras can be deployed to allow one observer to centrally observe all of the pens and ensure that the feed product is being eaten and to monitor when the fish have stopped feeding. Accordingly, the automated system can be controlled from a central location decreasing the amount of labor and to some extent, subjectivity involved in the feeding process.

In certain embodiments, additives can be included with the extruded product. For example, fish oil can be included in order to increase the percentage of fat, which can increase the size and in certain instances the quality of the fish. In addition, vitamins can be added to the extruded product in order to increase the health and quality of the fish. In certain embodiments, additives can be included in order to improve the color of the harvested fish. For example, increasing the fat content of bluefin tuna can also decrease the characteristic red color of the harvested fish. Including, e.g., krill, can actually help restore the characteristic red coloring. In other embodiments, other additives such as fish meal can also be added. Thus, not only can the desired growth rate be achieved with less feed product, but the overall quality and attractiveness of the harvested fish can be increased substantially as well.

As a result of the systems and methods described herein, significant cost savings and production increases can be achieved for various farmed fishes. While the embodiments described above relate primarily to bluefin tuna, it will be clear to one of skill in the art that other fishes can benefit from the systems and methods described herein, through the use of other variations of the extruded feed product. For example, other fishes such as salmon, various types of fresh and saltwater bass, yellow tail, etc., can also benefit from extruded fish feed developed specifically for the target fish.

In this regard, it should be noted that different fish types have different feeding characteristics. For example, some fish feed more by sight and others more by smell. Therefore, the extruded feed product can be designed to achieve the optimum shape and length, as described above, as well as the optimum color and in some instances, smell. For example, additives can be added to the extruded feed product in order to achieve the desired color to ensure optimum feeding. In other embodiments, a scent can be added to the extruded feed product. For example, a scent can be added to the casing in order to achieve optimum feeding.

In other embodiments, the feed can be blended with algae product in order to farm an algenate feed product. Such product can last longer prior to being used and can eliminate the need for a casing.

The following descriptions relate to several experiments engaged in to determine the right consistency and ingredients as well as the effectiveness for a feed product such as that described above.

The experiments described below were engaged in to addressed the decline of fat in tuna being farmed with conventional methods, given that this problem had a direct impact on the low prices of tuna sold. First, a comparative study of the percentage of fat in sardines from the 2006-2007 season in relation to the 2 previous seasons was carried out and the conclusion was the decline of fat in sardines had a direct influence on the decline of fat in tuna, and that this problem was primarily presented during the winter.

Tests were carried out comprising adding fats of vegetable and animal origin to sardines, and finally, a report was made where various forms and presentations of adding fats were suggested. Among these proposals, the presentation of coated and fresh sardine based pellets was highlighted as discussed in detail below.

Feeding was then modified from 2 times per day to 3 feedings per day. An improvement in conditions indexes was obtained as the result of feedings with fresh sardines 3 times per day and coated sardines in the experimentation pens also described below in detail.

It was necessary to carry out an in depth study to search for the primary factors that were influencing the decline of fat in tuna, whereby a detailed analysis of the conditions indexes of harvested tuna (the relationship between weight and length), an analysis of fat in sardines, and hematological analyses were carried out. This experimentation is also described in detail below.

It was concluded that 50% of the tuna had in fact been sold with an index lower than 21 (conditions indexes greater than 21 are considered optimal in fat) and that the primary factors that triggered the problem of the decline of fat in tuna were: 1) the low percentage of fat in the sardines 2) the decline in sardine consumption.

A 1½ Torrey mill was acquired and fresh sardine based pellets, e.g., as described above, were made with vitamins, fish meal and/or fish oil. Different sizes were tested and they were given to the tuna with 95% acceptance.

The experiment was carried out on a larger scale, leaving a pen with approximately 460 tuna as an experiment and marking them for the purpose of recording the initial weight and length prior to administering fresh sardine based pellets.

A machine with the function of grinding, mixing, and stuffing at least 200 kilograms of sardine pellets daily was acquired to initiate feeding with sardine pellets, which have been administered gradually to avoid stressing the tuna due the change from fresh sardine feed as described below. Satisfactory results in feedings with fresh sardine based pellets were achieved also as described below.

A cost analysis of the pellet filling and casings was carried out, which is detailed below.

First, as described above an analysis of the annual trends of fat content in sardines during different seasons was carried out for the purpose of seeing if the quality of the sardine has an effect on the quality of the tuna that is being fattened.

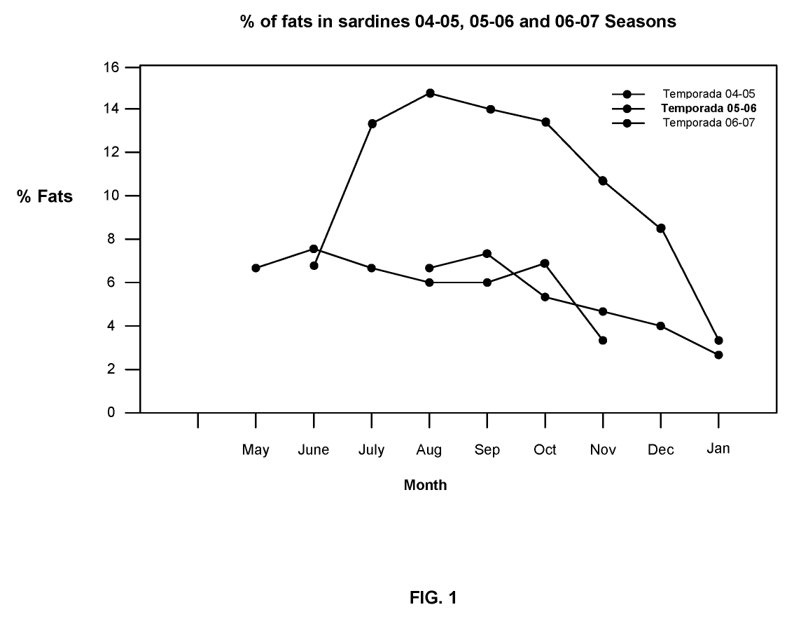

It can be seen in FIG. 1 that in the 06-07 season, the fat content in sardines declined considerably in comparison with previous years, with the exception of the month of October. Further, it can be seen that November, December, and January are the critical months for the fat content in sardines used as feed for the tuna.

From this data several preventative measures, to avoid the drop in fat content were developed: 1.—Increase feeding frequency considering the interval of hours between feedings (it is necessary it carry out tests of the time for the alimentary bolus to pass through the digestive system of the tuna) for the purpose of being certain that the animal makes use of the sardine that it is being given and not wasting feed, which could be a source of organic contamination to the marine floor; 2.—Increase the concentration of vitamins: In accordance with the vitamin requirements of the tuna, increasing the daily dosage that is currently administered to the tuna; and 3.—Enriching sardines with fats from vegetable sources: One method of management for supplying a constant fat quality in the tuna is enriching the sardines with fats from vegetable sources. The optimal quantity and appropriate manner of application that is advantageous for the tuna and that do not harm water quality should be determined and testing was carried out in this regard.

### Fat Addition Experiments in Sardines

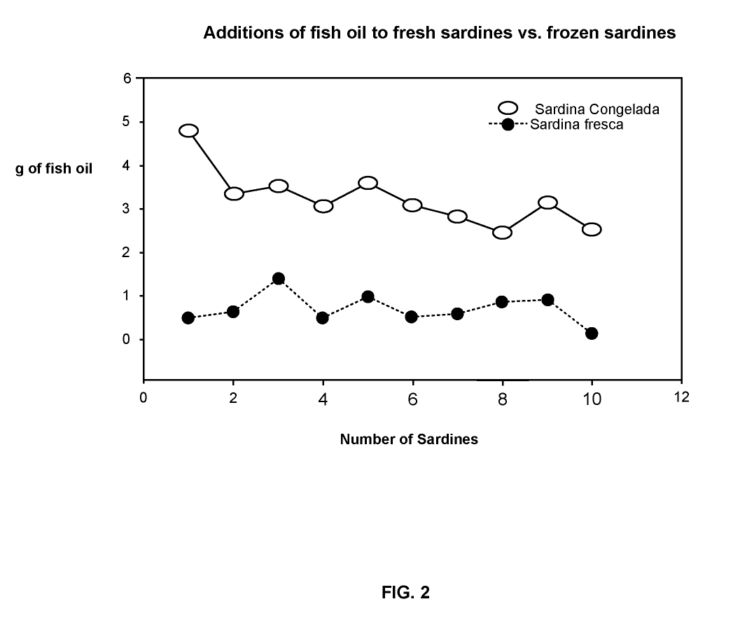

Tests of the addition of fish oil to fresh and frozen sardines of different sizes were carried out, and in FIG. 2 it is observed that the greatest quantity of fish oil remained adhered to frozen sardines compared to fresh sardines, the explication of which is that fish fats tend to solidify at lower temperatures and therefore have greater adhesion capacity.

In order to solve the problem of the adhesion of fish oil to FRESH sardines, a mixture of this oil with fats of vegetable origin (palm, coconut) and oils of animal origin (lard) was resorted to.

In table 1, the different experiments of mixtures of fish oil and fats of vegetable and animal origin are shown.

TABLE 1
Experiments of mixtures of fish oil and fats of
vegetable and animal origin.

| Proportion (1 part) | Proportion (9 parts) | Adhesion |
|---|---|---|
| Soy oil | Fish oil | 5% |
| Palm oil | Fish oil | 10% |
| Coconut oil | Fish oil | 70% |
| Animal lard | Fish oil | 90% |

Several approaches to add oil and fats to the feed were tried in order to draw conclusions as to the best approach to add fat to the tuna.

A) Sardine Coating Procedure (the Addition of the Oil-Fat Mixture with Fish Meal) for Fresh Sardines
1.—Add the fish oil and lard mixture (the laboratory makes the mixture prior to sending it to the barge) to the drained FRESH sardines.
2.—Sprinkle fish meal mixed with 7% Carboxymethyl cellulose (CMC) over the fresh sardines that already contain the fat mixture.
3.—Feed the tuna with these sardines two to three times per day.
Dose: 100 kg of the fish oil-lard mixture and 50 kg of fish meal per ton of sardines.

### B) Procedure for Adding Fish Oil to Frozen Sardines.

1.—Freeze the fresh sardines at least at −20° C.
2.—Add fish oil to the frozen sardines
3.—Let the fish oil settle over the sardines for 10 minutes
4.—Feed the tuna with frozen sardines-fish oil
Dose: 10% to 20% fat may be added to the sardines. 100 kg to 200 kg of fish oil per ton of sardines.
C) Procedure for the Manufacture of Sardine Pellets with Fish Oil
1.—Grind fresh or frozen sardines
2.—Add up to 20 to 30% fish oil
3.—Homogenize the mixture
4.—Pack the mixture in cellulose pellets
5.—Cut 10 cm lengths with a weight of 60 grams
6.—Feed the tuna two times per day
1 ton of mixture=700 to 800 kg of sardines with 200 to 300 kg of fish oil.
D) Procedure for the Manufacture of Fish Meal Pellets with Fish Oil
1.—Weigh 700 to 800 kilos of fish meal
2.—Add up to 20 to 30% fish oil (200 to 300 kilos)
3.—Homogenize the mixture
4.—Pack the mixture in cellulose pellets
5.—Cut 10 cm long pieces with a weight of 60 grams
6.—Feed the tuna two times per day

### Equivalent to 20 and 30% fat

E) Fresh Sardines with Fish Oil Encapsulated in Cellulose
1.—Insert the fresh sardines in the cellulose covering
2.—Add 10 to 15 g of fish oil
3.—Remove the air bubbles
4.—Tie the covering

### Equal to 20 and 30% fat.

Carnivorous fish digest less than 10% of cellulose (Stoskopt, 1993), and the percentage of the capsules is 4%, whereby they are believed to be digestible in fish.

Based on testing using the above approaches it was determined that using moist fresh or frozen sardine based pellets enriched with fish oil, or using dry fish meal based pellets with fish oil enrichment, i.e., approaches C, D and E, works best to add fat to the tuna. Moreover it allows control of fat percentage in the feed and therefore fluctuations in the fat of the tuna can be eliminated or reduced.

The following details the results of the studies carried out to determine the primary factors influencing the decline in fat in the tuna and the resulting determinations with respect to how to move the distribution of the population towards the right, having more kilograms of tuna, fat, and quality as the result.

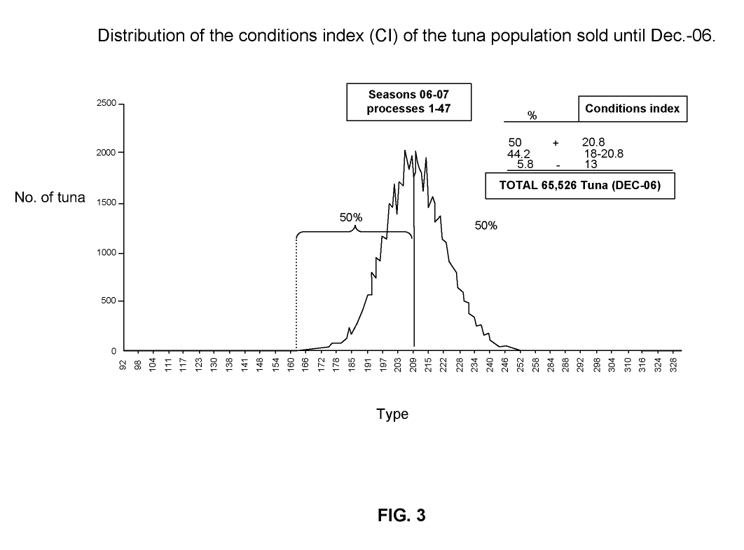

Referring to FIG. 3, and considering the condition index (CI=Body weight/L³) as the most appropriate tool to indicate the state of fat accumulated in the tuna, it may be observed that 50% of the product sold had a condition index below the desired range (21-23).

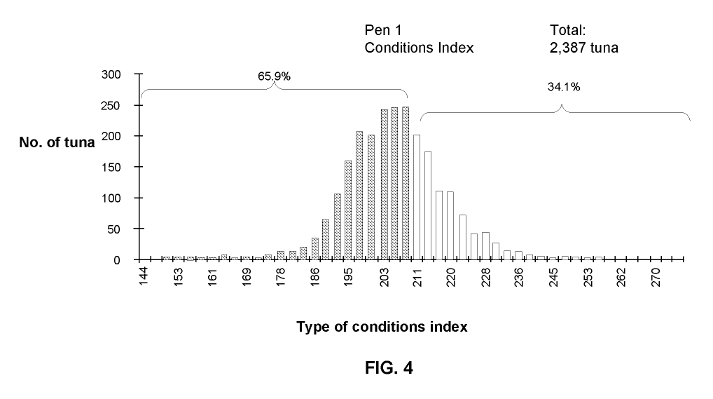

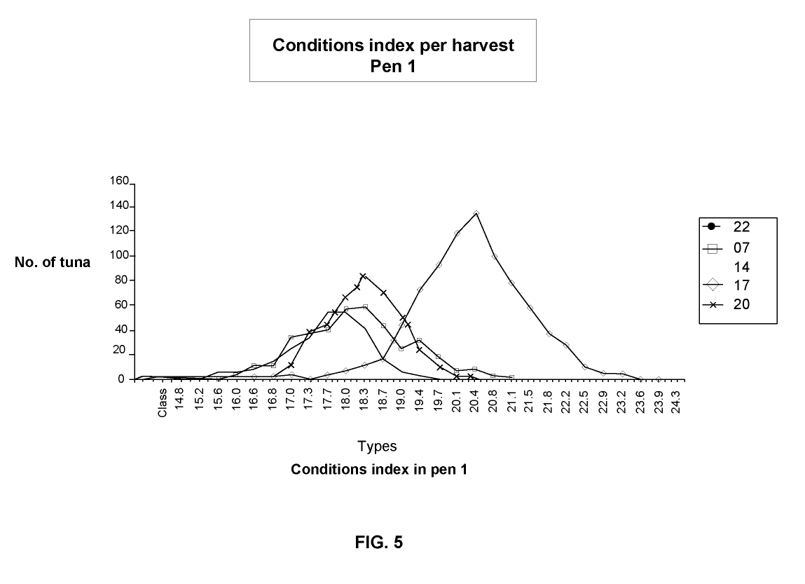

With respect to FIGS. 4 and 5 the distribution of the Conditions Index per pen are shown. Only the most representative pens are shown, which allows the general state of the CI of the relevant tuna population to be indicated.

In FIG. 4 it can be seen that the majority (66%) of the tuna population had a CI below that desired (>21), the causes of which will be discussed in detail below.

In FIG. 5, the variations of the CI per harvest are shown. For example the July 14 process presented a very low CI, but on the other hand the CI of the July 20 process was much better than previous harvest. This is due to the fact that the strongest tuna flee at the moment of placing the net to harvest and therefore are the last to be harvested.

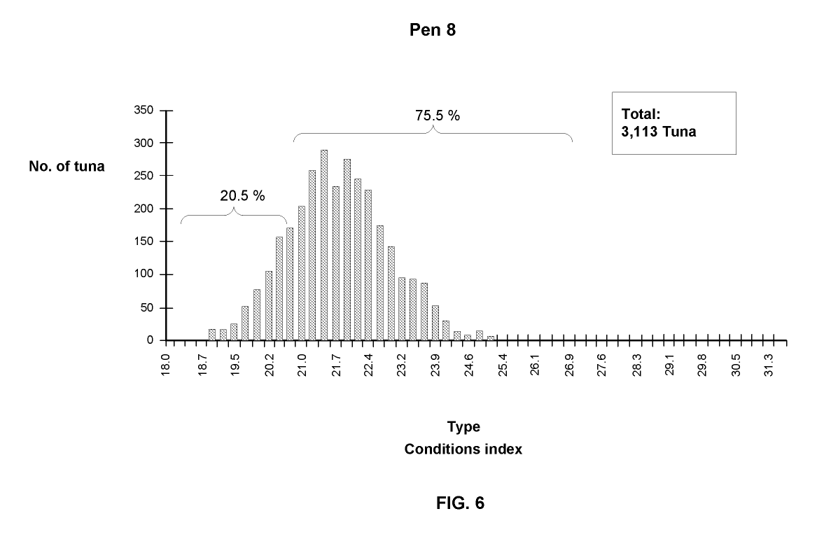

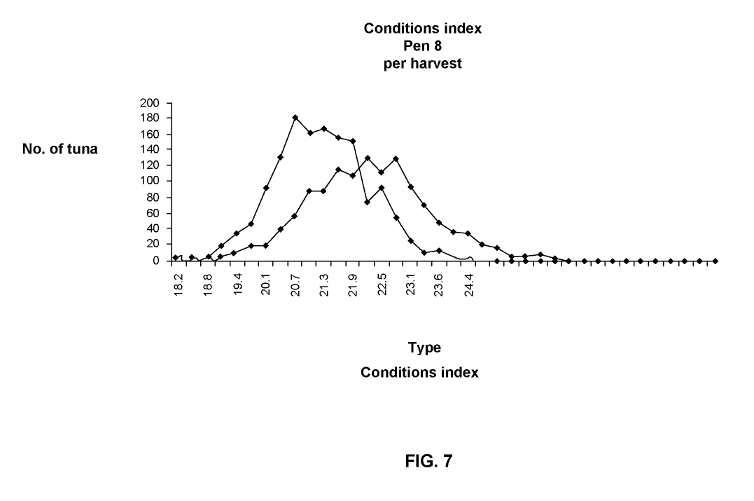

In FIG. 6 it can be seen that the majority of the tuna population (75.5%) presented a CI above that desired (>21). In FIG. 7 it can be seen that the distribution of the CI was also more homogeneous throughout the pen, which is reflected in the profile presented for each harvest. For example, the harvests of Oct. 19, 23, and 27, are more homogeneous and are closer to the CI of 21 compared to the profile presented in pen 1 in FIG. 5.

It is important to note that during fattening there were pens in which the tuna population presented a CI very close to that desired. For example, Pen 8 (see FIG. 6), and there were pens in which a large percentage of the tuna population did not reach the desired CI, e.g., Pen 1 (see FIG. 4).

There are many factors that affect sardine consumption in tuna, and therefore, only those which had a major impact on the behavior of the population in the pens will be mentioned.

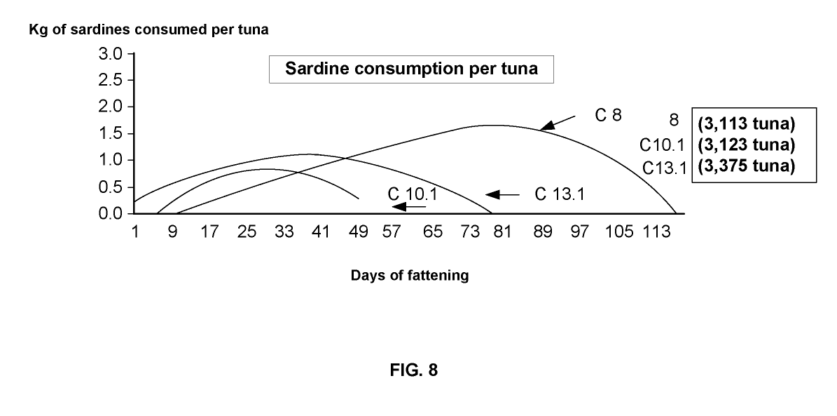

FIG. 8 provides an example that demonstrates the differences in sardine consumption in a pen with a LOW tuna population. Three pens with similar tuna populations are depicted on the graph and it is observed that despite their having the same density (number of tuna per pen), the feeding behavior (kg of sardines consumed per tuna) is different.

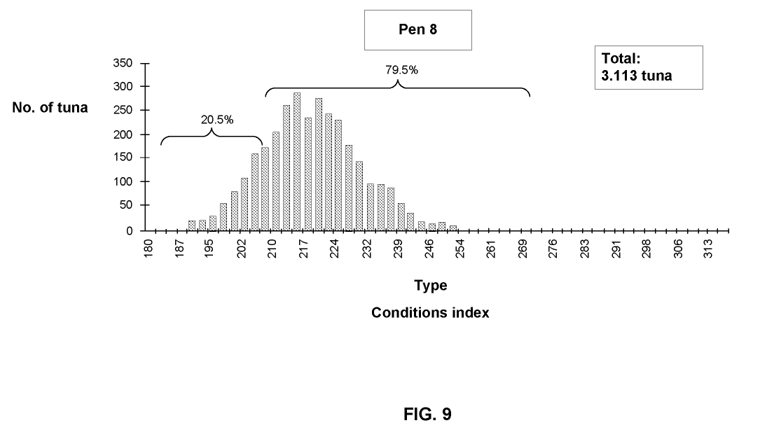

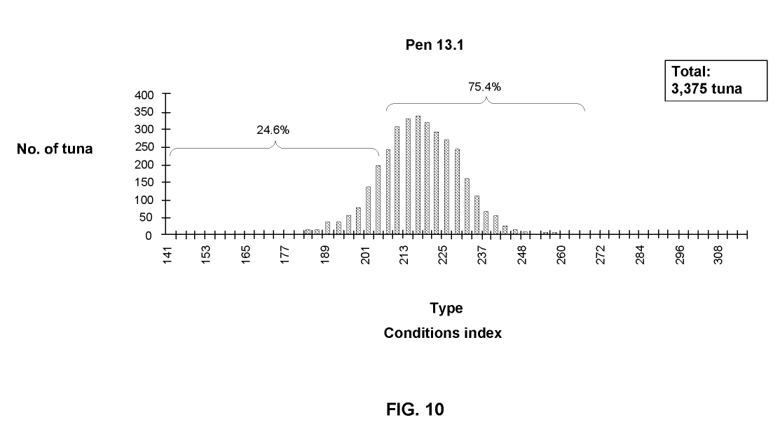

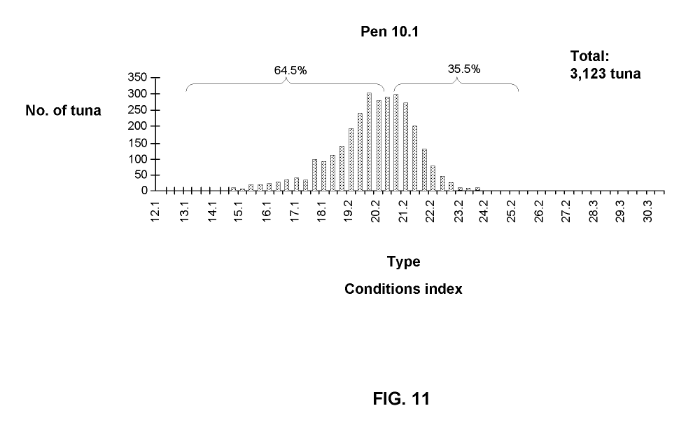

FIGS. 9-11 provide a comparison of quality of tuna obtained in relation to sardine consumption.

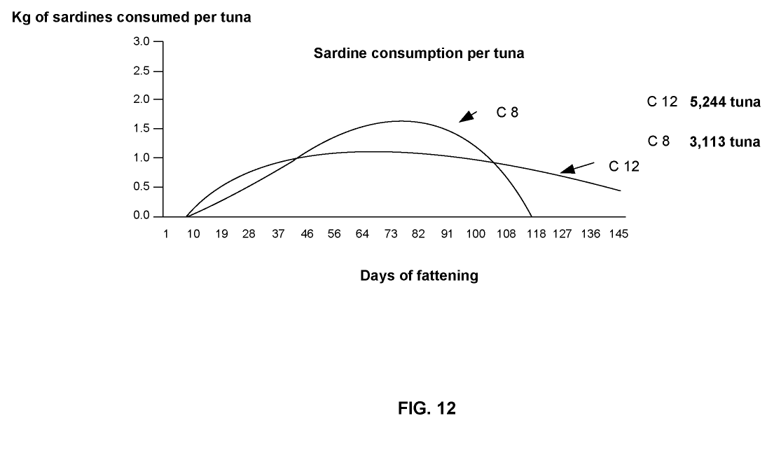

FIG. 12 provides an example that demonstrates differences in sardine consumption in pens with HIGH and LOW tuna populations. It can be seen that if there is an effect on the density (number of organisms per pen), pen C12 has lower consumption due to the fact that the quantity of tuna per pen is greater and therefore the sardines that are offered are shared between more organisms and in pen C8 the consumption per tuna was greater due to the fact that there is less competition for the food between the tuna.

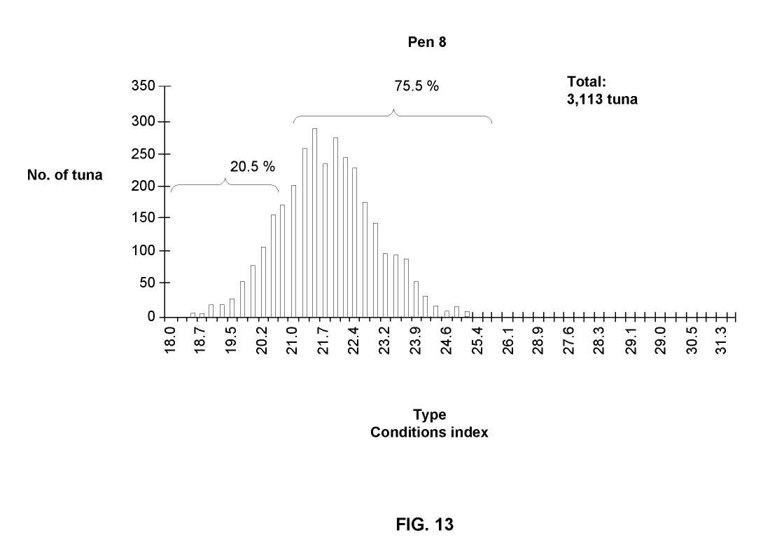

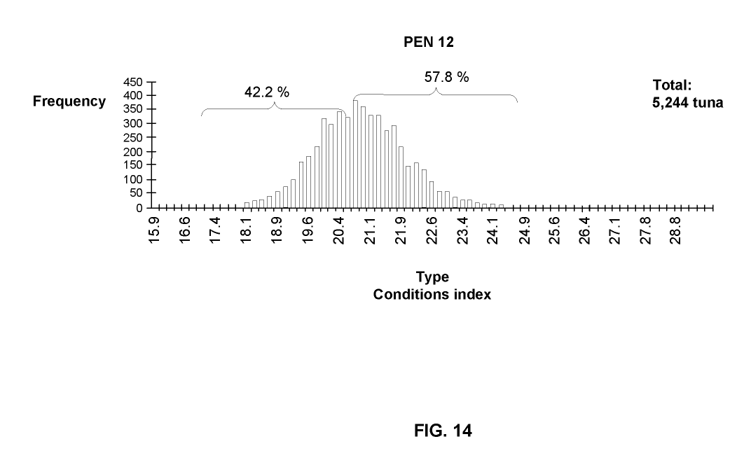

FIGS. 13 and 14 provide a comparison of quality obtained in relation to sardine consumption. The distribution of CI in a pen with high (see FIG. 13) and low (se FIG. 14) sardine consumption is shown and the CI distribution rates show how feeding affects quality. In pen 8, more of the tuna population (75.5%) was above the CI of 21 and in pen 12 the quantity of tuna with a desirable CI was much lower (57.8%).

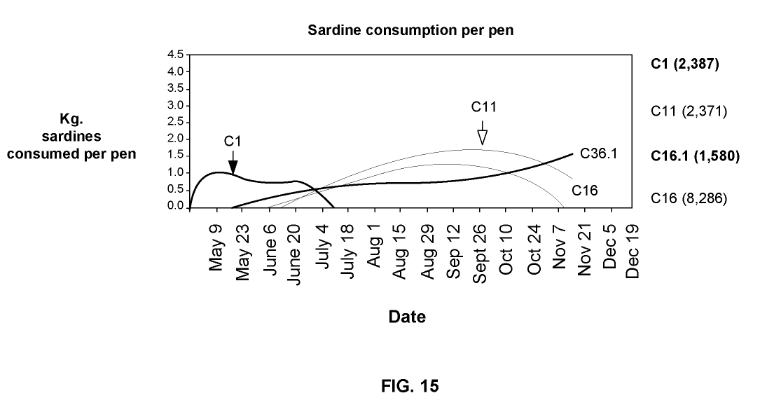

FIG. 15 illustrates the conditions of the marine environment on tuna. In FIG. 15 it can be seen that in terms of sardine consumption per pen, in addition to being influenced by the number of individuals, factors such as: date of arrival and duration of fattening also had a considerable effect on quality obtained (which will be shown further along).

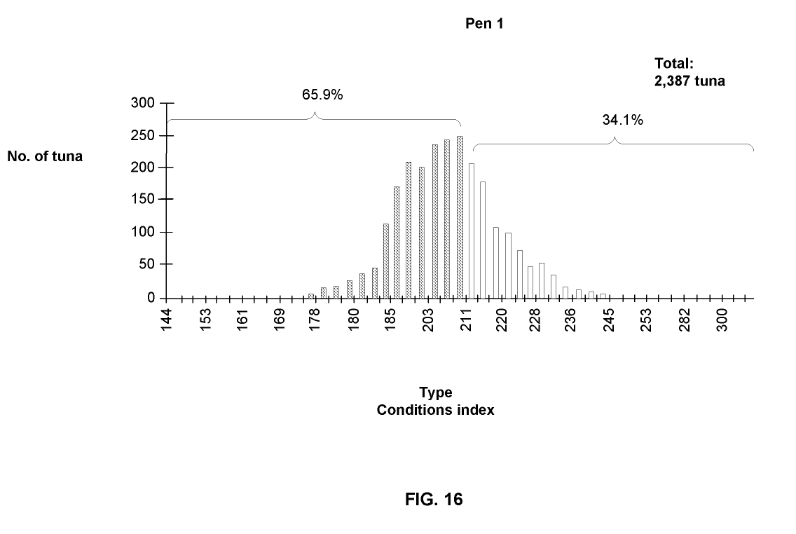

In Pen 1, the tendency line indicates very few days of fattening and in the middle of the fattening there was a decline in consumption, which is undoubtedly reflected in the conditions index obtained (See FIG. 16). In pens 11 and 16, the trend lines show that it took both 3 months (June 20-September 26) to reach maximum sardine consumption per tuna. Additionally, starting from October 24 the organisms started to reduce their consumption. In pen 16.1 a very different tendency is observed, given that it was the pen that received the recommendation of increasing feeding frequency, and for this reason it may be seen that the tendency line increases.

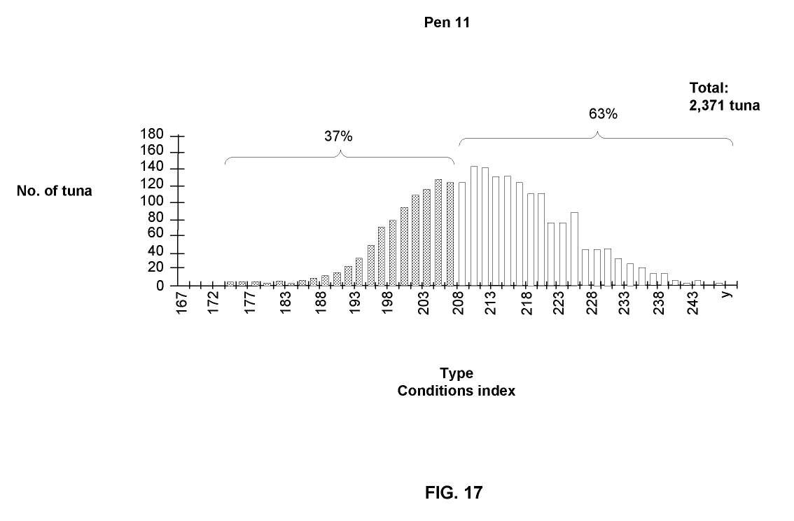

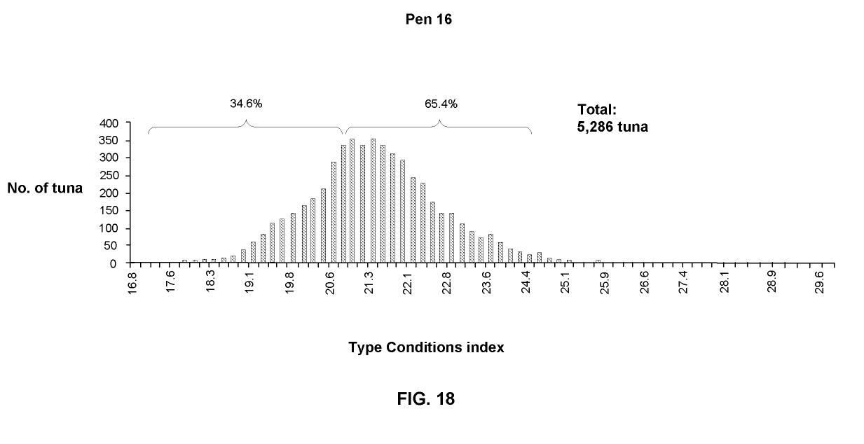

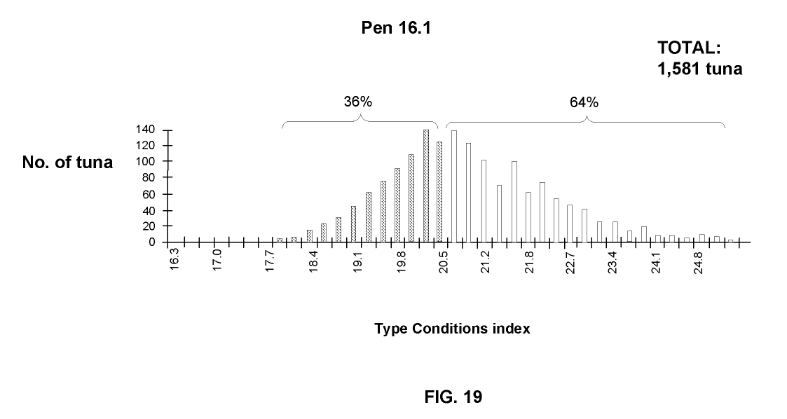

The distribution of the conditions indexes of the aforementioned pens is shown in FIGS. 16-19.

As can be seen in FIGS. 16-19, pen 11 showed high consumption (due to its low population). The figures also demonstrates how low sardine consumption (and the decline in fat) at the end of the season resulted in the conditions index achieved by 60% of the population in pens 11, 16, and 16.1.

Further, Pens 11 and 16 had similar CI distributions despite the low consumption detected in pen 16, which indicates that there are other factors that are affecting consumption, such as handling the tuna from shipment, feeding, and the management of sardine consumption information, etc.

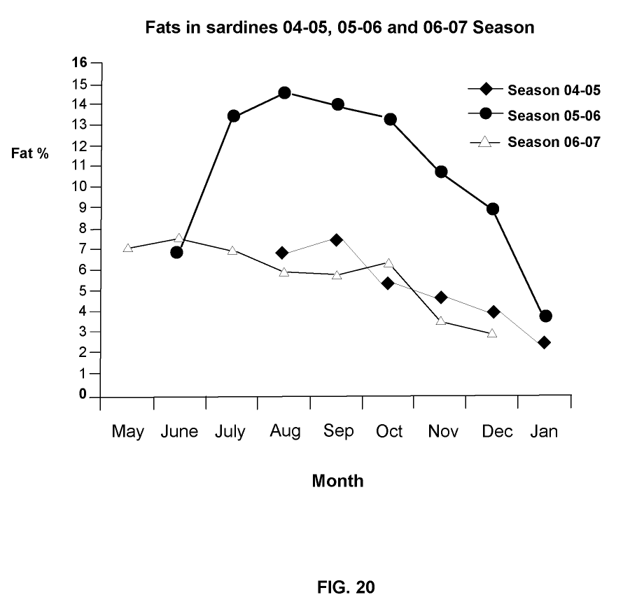

FIG. 20 illustrated fats in sardines for the 04-05, 05-06 and 06-07 seasons. In FIG. 20, it is clearly observed that the 05-06 season was the best for fat in sardines and that in general, and that seasons 04-05 and 06-07 were generally similar with the exception of the critical months of August, September, and October.

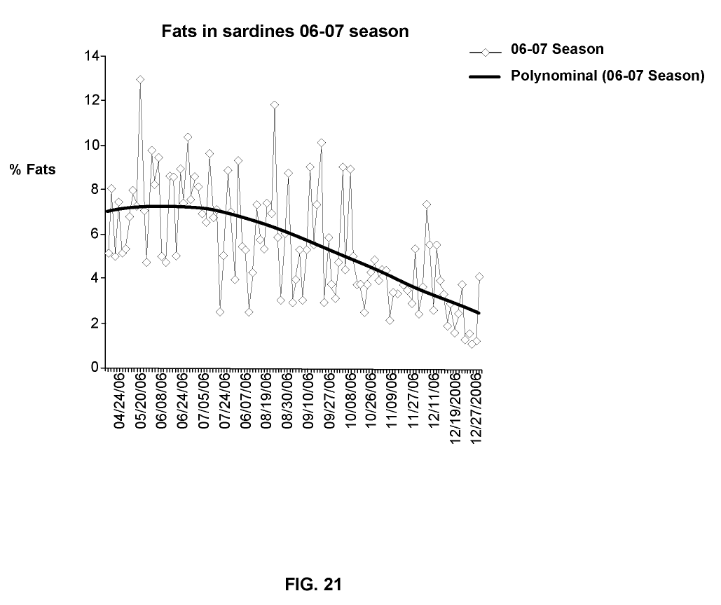

FIG. 21 illustrates the sardine fats for the 06-07 season. It is necessary to maintain 7% and 8% fat in sardines in the period from June to September, and if the percentage decreases, to increase feeding frequency. In general, FIG. 21 shows fluctuations of the percentage of fat in sardines in the 06-07 season, being most notable in the months of August and September with a slight rebound in October and a notable decline in December.

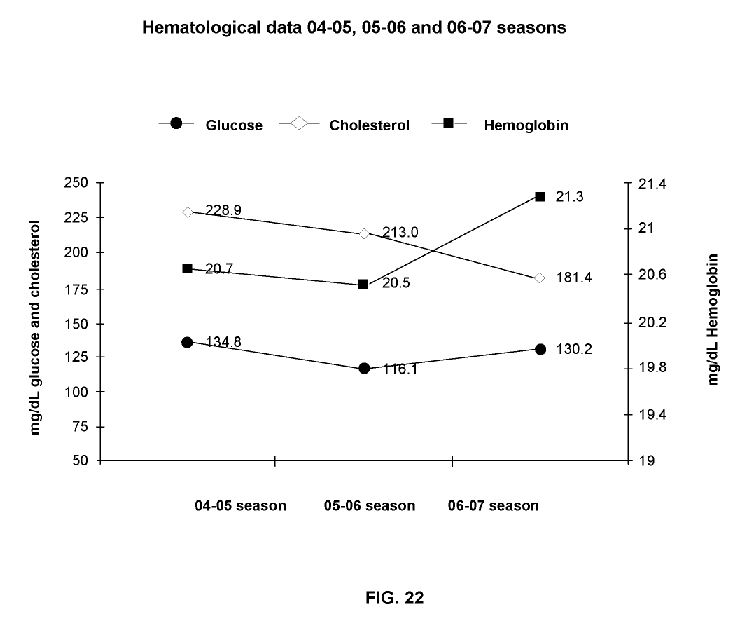

FIG. 22 illustrates hematological data for the 04-05, 05-06 and 06-07 seasons. An analysis of 900 blood samples was carried out in blue fin tuna, providing the glucose, cholesterol, and hemoglobin averages from three seasons. Glucose indicates the stress level in the fish, as the increase in blood glucose concentrations increases the stress level. Normal levels of glucose in blue fin tuna are 100-120 mg/dL.

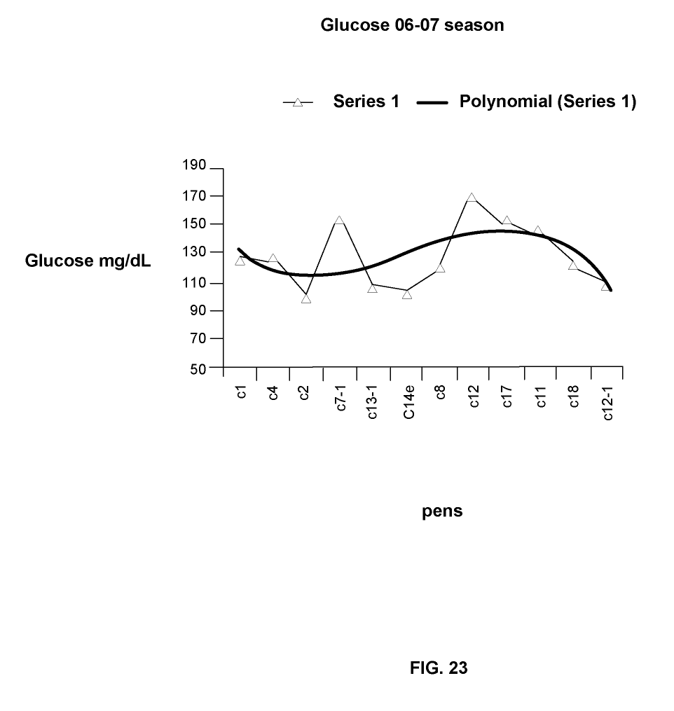

On average, the 04-05 and 06-07 seasons are similar, however, when each one of the pens are analyzed separately, it may be observed in FIG. 23 that the most stressed pens are 7-1, 12, 17, 11 and 16, having levels above 150 mg/dL, high compared to other seasons. The least stressed tuna are pens 1, 4, 2, 13-1, 14 and 8. Pens 7-1, 12, 17, 11 and 16 were geographical separated from pens 1, 4, 2, 13-1, 14 and 8.

High glucose values up to 170 mg/dl were NEVER presented. Contributing factors: 1) Too much movement; and 2) Increase in the presence of sea lions.

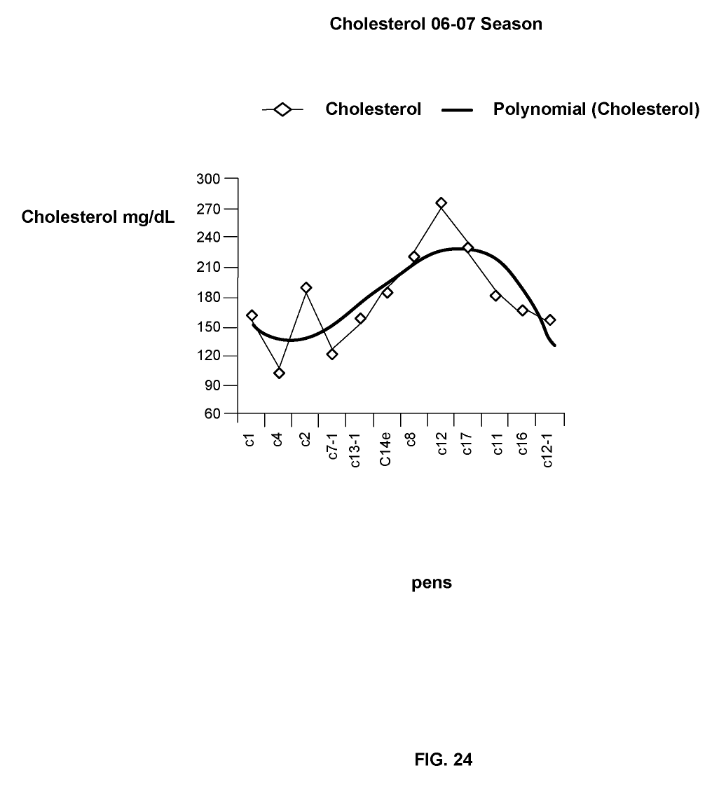

The blood cholesterol of the tuna indicates the presence of sardine fat, and in this season, levels below normal (200-240 mg/dl) were presented, and blood cholesterol values in the blue fin tuna were up to 90 mg/dl as seen in FIG. 24.

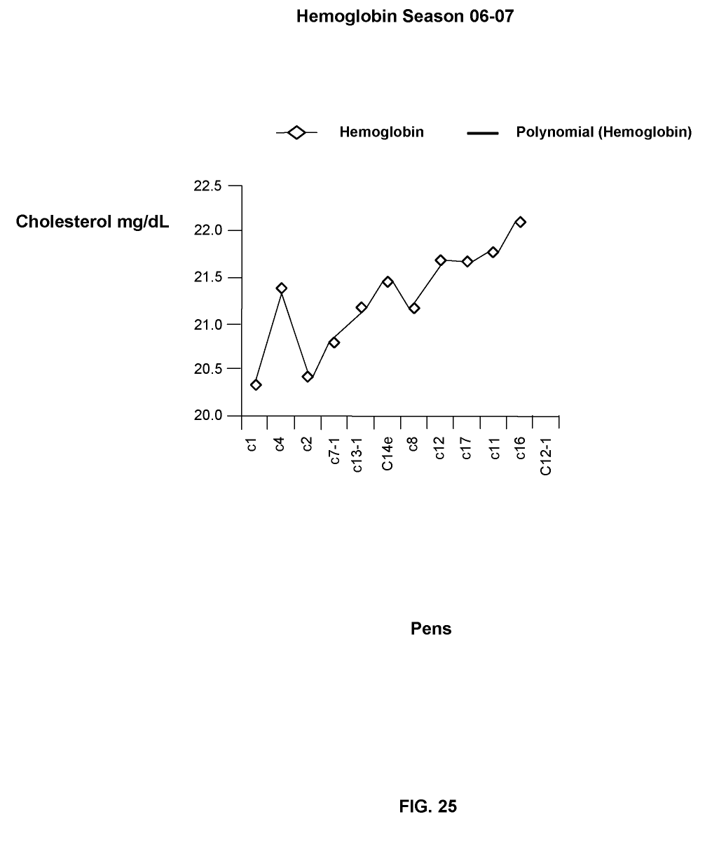

FIG. 25 illustrated the blood hemoglobin of the blue fin tuna. Hemoglobin is a blood protein that indicates the level of malnutrition of the tuna. Low values had been observed in previous seasons compared to this 06-07 season; this indicates that they were nourished with sardines rich in proteins and that the effect of the coloration of the tissue of the tuna is influenced by hemoglobin, that is, red muscle.

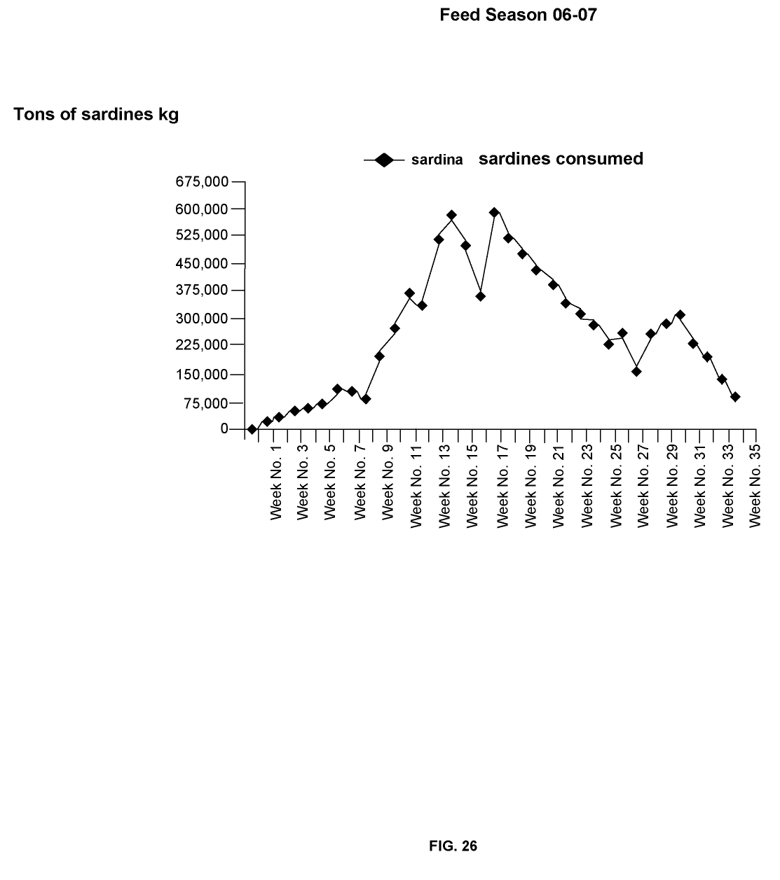

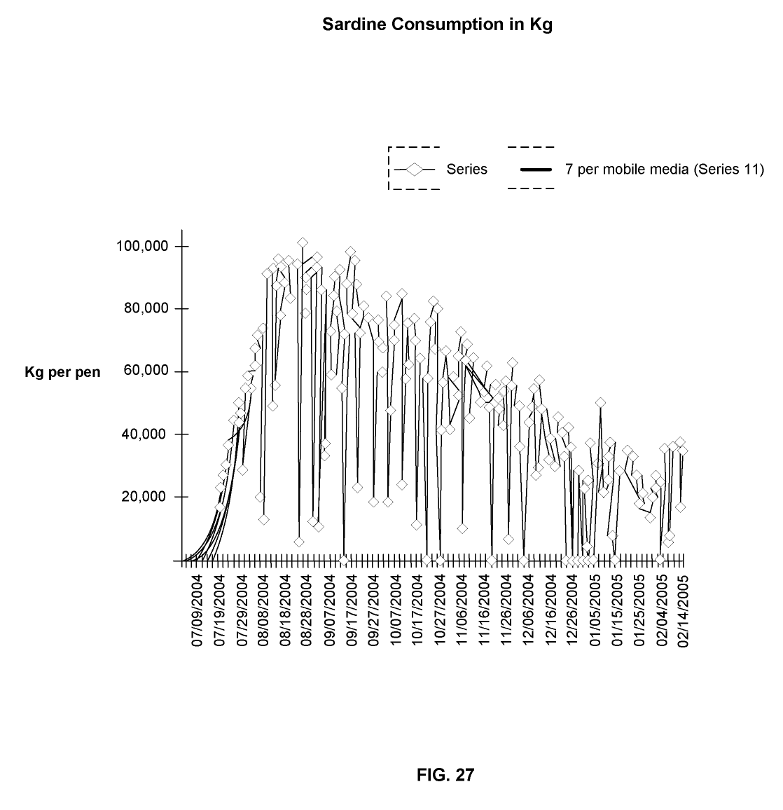

The sardine consumption trend in the 06-07 and 04-05 seasons are shown in FIGS. 26 and 27, where it can be seen that the sardine consumption tendency in this season declined in relation to the 04-05 season.

The design of a prepared feed pellet based on fresh sardines with natural additives, such as oil, fish meal, and vitamins, will now be described. First, materials that had the primary characteristic of being natural in origin and edible were sought, providing the result that the best material was natural pork intestines and/or collagen coverings.

The formula for the pellet was then designed on the basis of the nutritional requirements of the tuna considering the energy expenditure and conditions observed in the pens, the formula being, e.g., 79.5% protein, 20% fat, and 0.5% vitamins. In order to determine the ideal size of the pellets, the experiment carried out in the field was taken into account, the optimal size being approximately 8 cm. in length with a diameter of 3-4 cm.

The covering of the pellets should be accepted and consumed by the tuna, low cost, resistant to handling in the field, and easy to pack. Each pellet should contain high quality ingredients and provide a greater quantity of nutrients (fat, protein, and vitamins) to the tuna compared to the sardines caught in the area.

In one example, the ingredients of the pellets include:

| | |
|---|---|
| Fresh sardines | 60.2% |
| Fish meal | 19.57% |
| Fish oil | 19.57% |
| Kreel meal and vitamins | 0.602% |

The kilograms of each ingredient used for 1 ton of feed

| Ingredient | kg |
|---|---|
| Fresh sardines | 602 |
| Fish meal | 195.7 |
| Fish oil | 195.7 |
| Kreel meal and | 6.02 |
| vitamins | |
| Total | 1,000 |

Three types of pellets can be manufactured: a) Small pellets (30-40 g); pellets designed for tuna <20 kilos; b) Medium pellets (40-50 g); pellets designed for tuna from 20 to 30 kilos; and c) Large pellets (50-70 g); pellets designed for tuna >30 kilos.

In table 1, the different types of coverings for the manufacture of pellets found on the market are shown, as well as their production performance, cost per unit and by ton of pellet produced. It may be observed that the most expensive covering is collagen, given that it is a product of German origin, its characteristics being that it is edible and digestible by tuna. In second place are natural pork intestines, which are also edible and digestible by tuna, and finally, the most economic option is cellulose covering, though it may present the disadvantage of not being digested by the tuna.

Thus, the most economic option with the desired characteristics is natural pork intestines.

TABLE 1
Costs of the different coverings (wrappings)
that may be used in the pellets

| | | Cost | Yield in kg | cost of covering × |
|---|---|---|---|---|
| Type of covering | meters | USD | of pellets | ton of pellets |
| Natural (kg intestines) | 80 | 13.7 | 40 | 341.5 |
| Collagen (roll) | 100 | 29 | 50 | 580 |
| Cellulose | 30 | 2 | 15 | 133.3 |

In table 2, the costs of the ingredients needed to manufacture the filling (paste) of the pellets, in accordance with one example embodiment, are presented. The most expensive ingredients, considering the proportion that would be used, would be the fish meal and fish oil. However, it is important to mention that fresh sardines contain 80% water, which is why they have a lower cost than fish meal, which has 7% water and which makes it a concentrated feed (see Table 4).

TABLE 2
Costs of ingredients for the manufacture of the pellet filling.

| | % of | kg. of | Cost in | Cost in USD |
|---|---|---|---|---|
| | ingredient | ingredient/ | USD | per kg to |
| | in | ton | per ton of | produce 1 |
| Raw materials | pellets | of pellets | Ingredient | ton of pellets |
| Fresh sardines | 60.2 | 602.0 | 70 | 42.1 |
| Fish meal | 19.6 | 196 | 752 | 147.3 |
| Fish oil | 19.6 | 196 | 525 | 102.9 |
| Krill with vitamins | 0.6 | 6 | 2700 | 16.2 |
| Total | 100 | 1000 | | 308.6 |

In table 3, the production cost of the manufacture of pellets are described considering the price of filling to be constant, and what would vary is the cost of the covering.

TABLE 3
Production cost of pellets with different coverings

| | Cost in USD of | Cost in USD × | Cost per ton of |
|---|---|---|---|
| | covering × ton | ton of pellet | pellets (paste |
| Type of covering | of pellets | fill (paste) | and covering) |
| Natural (kg intestines) | 341.5 | 308.6 | 650.1 |
| Collagen (roll) | 580.0 | 308.6 | 888.6 |
| Cellulose | 133.3 | 308.6 | 442.0 |

In table 4 it can be seen that the pellets present 5.5 times more fat and 1.5 to 2 times more protein than sardines. Sardines reach a cost of 70 Dollars per ton; however, the pellet filling has a cost of 308.6 Dollars, which is 6 to 7 times richer in fats and proteins. Therefore, the 70 Dollars for the ton of sardines multiplied by a factor of 6 to 7 times converts the equivalent cost of sardines to 420 to 490 Dollars compared to the 308.6 Dollars of the pellets.

Frozen sardines have an approximate cost of 300 Dollars, and if we consider that they do not have the desired 20% fat, then 2 to 3 tons of frozen sardines would have to be purchased (600 to 900 Dollars) to make the equivalent of a ton of pellet filling (308.6 Dollars). Thus, pellet filling (paste) is feasible in relation to fresh and frozen sardines, and also guarantees the consistent quality and quantity of the nutrients (fat and protein).

TABLE 4
Comparison of natural compositions between sardines, fish meal,
and pellets used to fatten tuna.

| Content | Sardines (%) | Fish meal (%) | Pellets (%) |
|---|---|---|---|
| Humidity (water) | 71.3 | 7.0 | 35 |
| Protein | 22.8 | 65.4 | 35 |
| Carbohydrates | 0.9 | 11.0 | 5 |
| Fat | 4.0 | 7.6 | 22 |
| Minerals | 1.0 | 9.0 | 3 |
| Fat | 100.0 | 100.0 | 100.0 |

The production costs of pellet paste are low compared to fresh and frozen sardines. The cost goes up when using natural coverings; for this reason, it may be preferable to use sodium alginate and gelatin as thickeners.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed:

1. A sausage like fed product, comprising:
a casing;
feed content comprising at least one fish type;
additives designed to increase the fat content of fish given the feed product;
a shape designed to make the feed product attractive to the fish; and
a size based on the size of the fish being fed the feed product.

2. The sausage like feed product of claim 1, wherein the feed content comprises at least one of sardines, mackerel, anchovy, and squid.

3. The sausage like feed product of claim 1, wherein the additives are further configured to increase or affect at least one of the quality and color of the fish.

4. The sausage like feed product of claim 1, wherein the additives are further designed to effect at least one of the sent and color of the feed product.

5. The sausage like feed product of claim 1, wherein the additives include at least one of fish oil, fats from vegetables, vitamins, krill, and fish meal.

6. The sausage like feed product of claim 1, wherein the casing is manufactured from at least one of intestines, collagen, and cellulose.

7. The sausage like feed product of claim 1, wherein the feed product is manufactured in one of three sizes, small, medium, and large.

8. The sausage like feed product of claim 7, wherein the small size is in the approximate range of 30-40 grams.

9. The sausage like feed product of claim 7, wherein the small size is in the approximate range of 40-50 grams.

10. The sausage like feed product of claim 7, wherein the small size is in the approximate range of 50-70 grams.

11. The sausage like feed product of claim 1, wherein the feed content comprises approximately 60.2 percent of the content of the contents of the feed product.

12. The sausage like feed product of claim 11, wherein the additives comprises approximately 40 percent of the content of the contents of the feed product.

13. The sausage like feed product of claim 12, wherein the additives include fish meal, fish oil, kreel meal and vitamins.

14. The sausage like feed product of claim 13, wherein the fish oil comprises approximately 19.6 percent.

15. The sausage like feed product of claim 13, wherein the fish meal comprises approximately 19.6 percent.

16. The sausage like feed product of claim 13, wherein the kreel meal and vitamins comprise approximately 0.6 percent.
